(19) United States
(12) Patent Application Publication
(10) Pub. No.: US 2011/0129162 A1
(43) Pub. Date: Jun. 2, 2011

(54) APPARATUS AND METHOD FOR LOSSLESS/NEAR-LOSSLESS IMAGE COMPRESSION

(75) Inventors: Kyeongpyo Kim, Daejeon (KR); Woo Yong Lee, Daejeon (KR); Young Ro Kim, Seoul (KR); HyunSang Park, Cheonan (KR)

(73) Assignee: Electronics and Telecommunications Research Institute, Daejeon (KR)

(21) Appl. No.: 12/957,207

(22) Filed: Nov. 30, 2010

(30) Foreign Application Priority Data
Nov. 30, 2009 (KR) 10-2009-0116693

(51) Int. Cl. G06K 9/36

(52) U.S. Cl. 382/238

(57) ABSTRACT

Provided is a lossless/near-lossless image compression apparatus and method. The lossless/near-lossless image compression method may include calculating a predicted value by predicting a pixel of a current location based on adjacent pixels, calculating an error that is a difference between the predicted value and a pixel value, and modulating the error to output the modulated error, encoding the modulated error, and controlling a tolerance based on a slice unit to enable a number of encoded bits to be the same as a target number of encoded bits. The tolerance may be set to be gradually increased or to be decreased to prevent a rapid change in the tolerance.

### CROSS-REFERENCE TO RELATED APPLICATION

This application claims the benefit of Korean Patent Application No. 10-2009-0116693, filed on Nov. 30, 2009, in the Korean Intellectual Property Office, the disclosure of which is incorporated herein by reference.

### BACKGROUND

1. Field of the Invention

The present invention relates to a lossless/near-lossless image compression apparatus and method, and more particularly, to a lossless/near-lossless image compression apparatus and method that may compress an image based on a desired capacity for transmission or storage.

2. Description of the Related Art

Lossless/near-lossless image encoding technologies may not distort image data, may cause a minimized loss, and may provide a service with a fine quality through a digital image media, such as a full HDTV, a medial movie, a movie, and the like.

Conventional lossless/near-lossless image compression methods may perform context-encoding of a prediction difference incurred by directions of edges of adjacent pixels. However, the conventional methods may use a fixed context-encoding scheme even though a difference in a compression rate is high due to a complexity of an image. Therefore, the conventional methods may not effectively adjust the compression rate according to a transmission bandwidth or a storage capacity.

Therefore, there is a desire for a lossless/near-lossless image compression apparatus and method that may minimize a loss based on the transmission bandwidth or the storage capacity to adaptively adjust the compression rate in real time.

### SUMMARY

An aspect of the present invention provides a lossless/near-lossless image compression apparatus and method.

Another aspect of the present invention also provides a lossless/near-lossless image compression apparatus and method that may compress an image based on a desired capacity for transmission or storage.

According to an aspect of the present invention, there is provided a lossless/near-lossless image compression apparatus including a ratio controller to control a tolerance based on a slice unit to enable a number of encoded bits to be the same as a target number of encoded bits, a prediction modulator to predict a pixel of a current location based on adjacent pixels to calculate a predicted value, to calculate an error that is a difference between the predicted value and a pixel value, and to modulate the error to output the modulated error, and an encoder to encode the modulated error.

According to an aspect of the present invention, there is provided a lossless/near-lossless image compression method including calculating a predicted value by predicting a pixel of a current location based on adjacent pixels, calculating an error that is a difference between the predicted value and a pixel value, and modulating the error to output the modulated error, encoding the modulated error, and controlling a tolerance based on a slice unit to enable a number of encoded bits to be the same as a target number of encoded bits.

Additional aspects, features, and/or advantages of the invention will be set forth in part in the description which follows and, in part, will be apparent from the description, or may be learned by practice of the invention.

### Effect

According to embodiments, a lossless/near-lossless image compressing apparatus and method may compress an image based on a desired capacity for transmission or storage, may control a tolerance to adjust a desired number of encoded bits, namely, a compression rate and thus, may minimize a loss based on a transmission bandwidth or a storage capacity, and may adaptively compress the image based on the desired number of encoded bits.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a configuration of a compression apparatus that may perform a lossless/near lossless compression of an image according to an embodiment of the present invention;

FIG. 2 is a diagram illustrating a ratio controller of a compression apparatus according to an embodiment of the present invention;

FIG. 3 is a diagram illustrating a configuration of a prediction modulator of a compression apparatus according to an embodiment of the present invention;

FIG. 4 is a diagram illustrating adjacent pixels used for calculating a predicted value of a pixel according to an embodiment of the present invention;

FIG. 5 is a diagram illustrating a configuration of an encoder of a compression apparatus according to an embodiment of the present invention;

FIG. 6 is a diagram illustrating an absolute value of errors of adjacent pixels used by a Golomb-encoder of a compression apparatus to calculate Golombk;

FIG. 7 is a diagram illustrating a decoder of a compression apparatus according to an embodiment of the present invention; and

FIG. 8 is a diagram illustrating a packing unit of a compression apparatus, the packing unit packing encoded data.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

Embodiments are described to explain a compression apparatus and method that may perform a lossless or near-lossless compression of image data to be transmitted or to be stored, to a desired capacity.

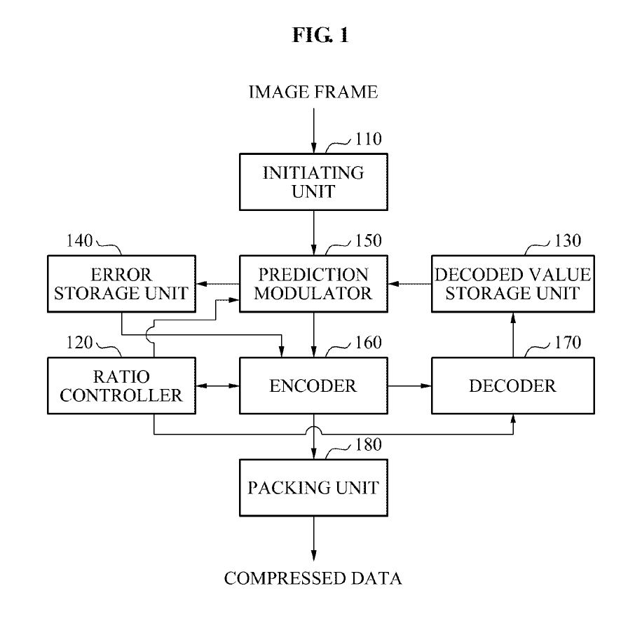

FIG. 1 illustrates a configuration of a compression apparatus that may perform a lossless/near lossless compression of an image according to an embodiment of the present invention. Referring to FIG. 1, an imaging apparatus according to an embodiment may include an initiating unit 110, a ratio controller 120, a decoded value storage unit 130, an error storage unit 140, a prediction modulator 150, an encoder 160, a decoder 170, and a packing unit 180.

When a new image frame is received, the initiating unit 110 may initiate the decoded value storage unit 130 and the error storage unit 140 before compressing the image, and may initiate parameters used for operating elements included in the imaging apparatus. The initiating unit 110 may set a maximum value of a pixel. The maximum value of the pixel may be set based on a number of bits of the pixel. For example, when the pixel is constituted by eight bits, the maximum value of the pixel may be set to 255.

The initiating unit 110 may set a target number of bits for each frame and for each slice, which may be used for the ratio controller 120. In this case, a slice may be a line of the frame. The initiating unit 110 may set the target number of bits for each frame by dividing, by a compression rate, a number of bits remaining after subtracting a number of bits of a header from a number of bits of an original image. The initiating unit 110 may calculate the target number of bits of for each slice by dividing the target number of bits of the frame by a number of slices. The initiating unit 110 may set a tolerance of encoded data to zero at a first line of the image.

An upper line of the first line of the image frame does not exist and an error does not exist and thus, the initiating unit 110 may set the tolerance of the first line to a predetermined value predetermined based on an experimentation. For example, the initiation unit 110 may set the tolerance of the first line to ‘5’.

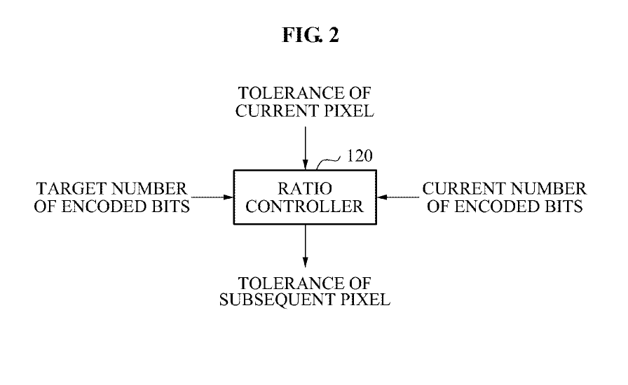

The ratio controller 120 may control the tolerance based on a slice unit. The ratio controller 120 will be described with reference to FIG. 2. FIG. 2 illustrates the ratio controller 120 of the compression apparatus according to an embodiment.

The ratio controller 120 may control the tolerance to be gradually increased or to be gradually decreased to prevent a rapid change in the tolerance. Therefore, a definition of the image may not be deteriorated.

The ratio controller 120 may determine a target number of encoded bits of a current location and a real number of encoded bits of the current location, and may control the tolerance of a subsequent slice to be encoded, based on following three cases.

First, the ratio controller 120 may increase the tolerance by a predetermined value when the number of encoded bits is greater than the target number of encoded bits. In this case, a number of bits to be encoded may increase. Second, the ratio controller 120 may decrease the tolerance by the predetermined value when the number of encoded bits is less than the target number of encoded bits. In this case, the number of bits to be encoded may decrease. According to the present embodiment, the radio controller 120 may set the predetermined value to ‘1’.

In the first and the second cases, the ratio controller 120 may set a change-alleviating value to prevent a radical change in the tolerance, and may compare the number of encoded bits with a value of a sum of the change-alleviating value and the target number of encoded bits. Here, the change-alleviating value may be a value acting as a buffer to reduce a number of changes incurred by frequent increase or decrease of the tolerance.

For example, the change-alleviating value may be set to 15% of the target number of encoded bits, to perform the comparison. Specifically, in the first and the second cases, the ratio controller 120 may compare the number of encoded bits with a value of a sum of the 15% of the target number of encoded bits and the target number of encoded bits, to control the tolerance.

Third, the ratio controller 120 may set the tolerance to ‘0’, when the tolerance is a negative number.

The ratio controller 120 may control a tolerance for each of R, G, and B representing a pixel. According to an embodiment, the same tolerance with respect to R, G, and B may be used to reduce an amount of calculations even though a small amount of deterioration of a definition is incurred.

The ratio controller 120 may increase or decrease the tolerance to values of 0, 1, 2, 4, 8, and the like and thus, a shift operation may decrease the amount of calculation.

The prediction modulator 150 may predict a pixel of the current location based on adjacent pixels, and may calculate an error that is a difference between the predicated value and a pixel value. The prediction modulator 150 may control an error range of the calculated error based the tolerance, and may modulate the error to provide the modulated error to the encoder 160.

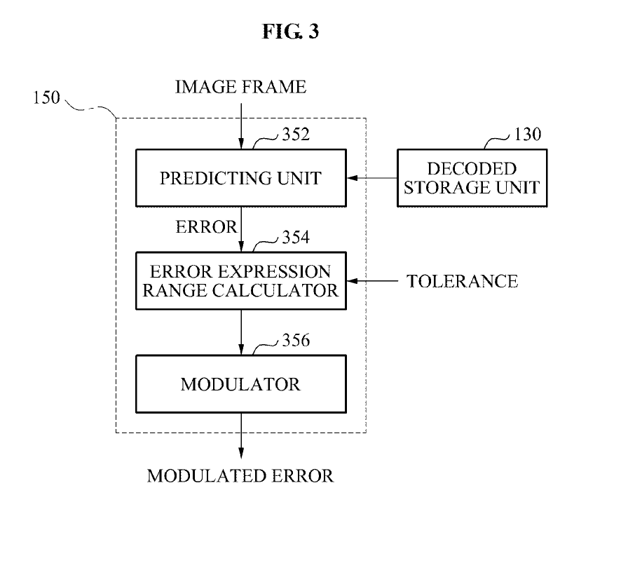

FIG. 3 illustrates a configuration of a prediction modulator of a compression apparatus according to an embodiment of the present invention. Referring to FIG. 3, the prediction modulator 150 may include a predicting unit 352, an error expression range calculator 354, and a modulator 356.

The predicting unit 352 may predict a pixel value of a current location based on adjacent pixels. However, a first input pixel of an image may not have the adjacent pixels and thus, a pixel value of the first input pixel may not be predicted. Therefore, the adjacent pixels of the first input pixel may be predetermined as ‘127’. Also, adjacent pixels of an upper line may not be used when a pixel of a first line is predicted. Therefore, the prediction of the pixel of the first line may be performed based on pixels of a previous location.

The predicting unit 352 may predict the pixel value of the current location to calculate an error that is a difference between a real pixel value of the current location and the predicted pixel value.

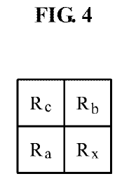

The predicting unit 352 may predict the pixel value of the current location based on a prediction scheme, such as a Linear scheme, a Least Mean Square (LMS) scheme, a Gradient Adaptive Predictor (GAP) scheme, a Median Edge Detector (MED) scheme, and the like. The pixel value of the current location may be predicted based on the MED scheme as illustrated in FIG. 4.

FIG. 4 illustrates adjacent pixels used for calculating a predicted value of a pixel according to an embodiment of the present invention. Referring to FIG. 4, the MED scheme may predict, using adjacent pixels, Ra, Rb, and Rc, a pixel value of a current location, namely, Ix, based on Equation 1. The predicted value, namely, Px, may be exactly the same as Ix or may be different from Ix.

if(Rc>=max(Ra,Rb)) {

Px=min(Ra.Rb);

}else if(Rc<=min(Ra,Rb)) {

Px=max(Ra,Rb);

}else}

Px=Rb+Ra−Rc;

} [Equation 1]

When a horizontal edge exists in an image, it may be assumed that Ra, Rb, Rc, and Ix have values of 0, 100, 100, and 0, respectively. The assumption may satisfy a first condition (Rc>=max(Ra,Rb)) of Equation 1, so Px=min(Ra,Rb) and thus, Px is 0. In this case, the error may be ‘0’. When a vertical edge exists in the image, it may be assumed that Ra, Rb, Rc, and Ix have values of 0, 100, 0, and 100, respectively. The assumption may satisfy a second condition (Rc<=min(Ra,Rb)) of Equation 1, so Px=max(Ra,Rb) and thus, Px is 100. In this case, the error may be ‘0’. When the horizontal edge and the vertical edge are not clear, i.e. when both the first condition and the second condition are not met, the predicting unit 352 may perform the prediction based on Px=Rb+Ra−Rc. Ra, Rb, and Rc may indicate adjacent pixels that may be predicted before the pixel value of the current location is predicted and may be decoded again. In a case of lossless compression, Ra, Rb, and Rc may have the same as original pixels. However, in a case of near-lossless compression, Ra, Rb, and Rc may be decoded values that may suffer from include errors within the tolerance. A decoding apparatus may use the decoded values when performing the prediction, since, in the near lossless compression, the adjacent pixels used for predicting are the decoded values as opposed to being original pixels. Therefore, the compression apparatus that is the decoding apparatus may also use decoded pixels as opposed to original pixel values, when performing prediction.

The error expression range calculator 354 may calculate an error expression range using the tolerance based on Equation 2 as expressed below.

If Near=0, RANGE=MAXVAL+1

If Near≠0, (MAXVAL+Near)/(2*Near)+1, [Equation 2]

wherein Near may denote the tolerance, RANGE may denote the error expression range, and MAXVAL may denote a maximum value expressed by pixels.

When Near is ‘0’, RANGE is ‘256’. When Near is ‘1’, RANGE is ‘129’. When Near is ‘2’, RANGE is ‘65’. When Near is ‘4’, RANGE is ‘33’.

The modulator 356 may modulate the error based on quantization so that the error is included in the error expression range.

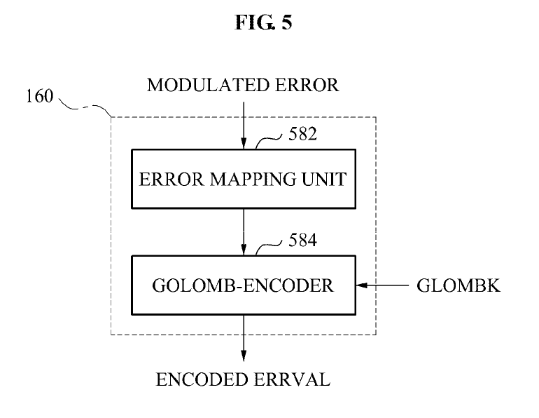

The encoder 160 may encode the modulated error that is received from the modulator 150. The encoder 160 may encode the modulated error based on Golomb-encoding scheme as illustrated in FIG. 5.

FIG. 5 illustrates a configuration of an encoder of a compression apparatus according to an embodiment of the present invention. Referring to FIG. 5, the encoder 160 may include an error mapping unit 582 and a Golomb-encoder 584.

The error mapping unit 582 may map the modulated error based on a predetermined scheme, to enable the modulated error to be a positive number. When the modulated error is a negative number, the error mapping unit 582 may multiply the modulated error by ‘−2’ and may add ‘−1’ to calculate a mapped value. When the modulated error is a positive number, the error mapping unit 582 may multiply the modulated error by ‘2’ to calculate the mapped value. For example, the error mapping unit 582 may map a modulated error ‘0’ as ‘0’, may map a modulated error ‘−1’ as ‘1’, may map a modulated error ‘1’ as ‘2’, may map a modulated error ‘−2’ as ‘3’, and may map a modulated error ‘2’ as ‘4’.

The Golomb-encoder 584 may not process a negative number and thus, the error mapping unit 582 may map a negative value as a positive value.

The Golomb-encoder 584 may calculate, using errors of adjacent pixels, Golombk that is a parameter used for Golomb-encoding first, and may Golomb-encode the modulated error that is mapped by the error mapping unit 582. The Golomb-encoder 584 may not use a separate table for storing codes while performing the Golomb-encoding. The Golomb-encoder 584 may divide the modulated error by ‘2’ to the Golombk^{th} power, namely, 2̂Golombk, to express the modulated error by a unary, a separator, and a binary. For example, when a predicted error is ‘20’ and Golombk is ‘4’, the predicted error may be encoded as 0 1 0100, in which is expressed by four bits in binary format. When Golombk is ‘1’, the predicted error may be encoded as 0000000000 1 0, in which is expressed by one bit in binary format. A number of encoded bits may depend on Golombk and thus, Golombk may be appropriately selected. Therefore, when the number of encoded bits is large, the number of encoded bits is limited to 32 bits or 16 bits.

When significantly large unary is calculated after the Golomb-encoder 584 divides the mapped modulated error by Golombk, an amount of encoding may excessively increase. Therefore, the number of encoded bits is limited to 16 bits according to an embodiment of the present invention. The Golomb-encoder 584 may classify a case where the unary is less than 7, namely, the unary is a short length coded unary, and a case where the unary is greater than or equal to 7, namely the unary is a long length coded unary. When the unary is less than 7, the Golomb-encoder 584 may perform general Golomb-coding, namely, may encode the modulated error as a unary, a separator, and a binary. However, when the unary is greater than or equal to 7, the Golomb-encoder 584 may express the modulated error by seven ‘0’, a separator ‘1’, and 8 bits of mapped error. For example, when the modulated error is ‘20’, Golombk is ‘1’, and the number of encoded bits is limited to 16 bits, the Golomb-encoder 584 may encode the modulated error as seven ‘0’, namely, ‘0000000’, a separator, namely, ‘1’, and ‘20’, namely, 00010100.

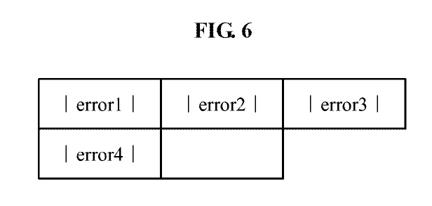

FIG. 6 illustrates an absolute value of errors of adjacent pixels used by a Golomb-encoder of a compression apparatus to calculate Golombk.

The Golomb-encoder 584 may calculate a total sum absolute difference (TSAD) by summing up all predicted error absolute values of adjacent pixels, and may compare TSAD with an increasing MVcnt to calculate Golombk as expressed in Equation 3. In this instance, MVcnt may denote a number of adjacent pixels used for calculating Golombk.

TSAD=0;

MVcnt=4;

TSAD=|error1|+|error2|+|error3|+|error4;

for(Goiombk =0; MVcnt<TSAD; Golombk++){

MVcnt=MVcnt*2;

} [Equation 3]

A smallest n satisfying Equation 4 may be calculated as Golombk, the Equation 4 being modulated from Equation 3.

MVcnt*2ⁿ≧TSAD [Equation 4]

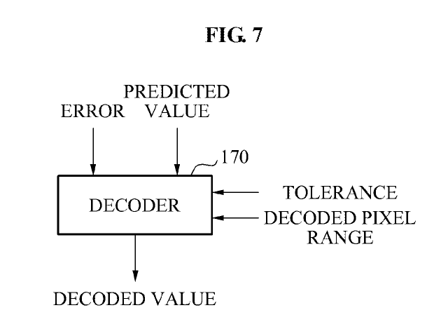

The decoder 170 may decode a predicted pixel that is predicted, by the predicting unit 352, to be used for the prediction of a subsequent pixel. FIG. 7 illustrates the decoder 170 of a compression apparatus according to an embodiment of the present invention.

The decoder 170 may calculate a primary decoded value by summing an error and a predicted value predicted by the predicting unit 352. The decoder 170 may calculate a secondary decoded value, namely, Rx, by controlling the primary decoded value based on a tolerance and RANGE_rec that is a decoded pixel range. The RANGE_rec may denote a range of a pixel that is decoded. The decoder 170 may map the secondary decoded value to be in the pixel expression range, namely, 8 bits: 0 through 255.

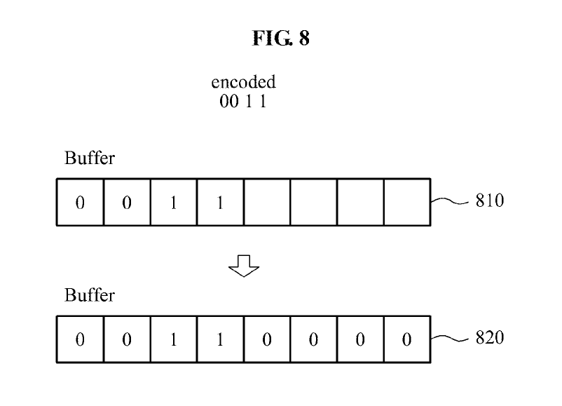

The packing unit 180 may store, in a file, encoded data or bits stored in a buffer based on a byte unit or may transmit the encoded data or bits stored in a buffer based on the byte unit. When a bit is insufficient since used units are in bytes, the packing unit 180 may perform a process of FIG. 8.

FIG. 8 illustrates a packing unit of a compression apparatus, the packing unit packing encoded data. Referring to FIG. 8, when a bit is insufficient in a byte unit in operation 810, the byte unit may be filled with ‘0’ instead of bits to generate a byte in operation 820.

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A lossless/near-lossless image compression apparatus, the apparatus comprising:
a ratio controller to control a tolerance based on a slice unit to enable a number of encoded bits to be the same as a target number of encoded bits;
a prediction modulator to predict a pixel of a current location based on adjacent pixels to calculate a predicted value, to calculate an error that is a difference between the predicted value and a pixel value, and to modulate the error to output the modulated error; and
an encoder to encode the modulated error.

2. The apparatus of claim 1, further comprising:
a decoder to decode the predicted pixel based on the error,
wherein the prediction modulator predicts the pixel based on adjacent decoded pixels.

3. The apparatus of claim 1, wherein the radio controller controls the tolerance to be gradually increased or decreased to prevent a rapid change in the tolerance.

4. The apparatus of claim 1, wherein the ratio controller performs:
increasing the tolerance by a predetermined value when the number of encoded bits is greater than the target number of encoded bits; and
decreasing the tolerance by the predetermined value when the number of the encoded bits is less than the target number of encoded bits.

5. The apparatus of claim 1, wherein the ratio controller performs:
increasing the tolerance by a predetermined value when the number of encoded bits is greater than a value of a sum of a change-alleviating value and the target number of encoded bits; and
decreasing the tolerance by the predetermined value when the number of encoded bits is less than the value of the sum of the change-alleviating value and the target number of encoded bits.

6. The apparatus of claim 5, wherein the change-alleviating value is a value acting as a buffer to reduce a number of changes incurred due to a frequent increase or decrease of the tolerance.

7. The apparatus of claim 1, wherein the radio controller sets the tolerance to zero when the tolerance is a negative number.

8. The apparatus of claim 1, wherein the encoder comprises:
an error mapping unit to map the modulated error to be a positive number; and
a Golomb-encoder to calculate, based on errors of the adjacent pixels, Golombk that is a parameter used for performing Golomb-encoding, and to Golomb-encode the mapped modulated error.

9. The apparatus of claim 8, wherein the Golomb encoder calculates Golombk as a smallest n satisfying Equation 5:
MVcnt×2ⁿ≧TSAD, [Equation 5]
wherein MVcnt denotes a number of adjacent pixels used for calculating Golombk, and TSAD denotes a value of summing up all absolute values of errors of the adjacent pixels.

10. A lossless/near-lossless image compression method, the method comprising:
calculating a predicted value by predicting a pixel of a current location based on adjacent pixels;
calculating an error that is a difference between the predicted value and a pixel value, and modulating the error to output the modulated error;
encoding the modulated error; and
controlling a tolerance based on a slice unit to enable a number of encoded bits to be the same as a target number of encoded bits.

11. The method of claim 10, further comprising:
decoding the predicted pixel based on the error,
wherein the calculating calculates the predicted value by predicting the pixel based on adjacent decoded pixels.

12. The method of claim 10, wherein the controlling comprises:
controlling the tolerance to be gradually increased or decreased to prevent a rapid change in the tolerance.

13. The method of claim 10, wherein the controlling comprises:
increasing the tolerance by a predetermined value when the number of encoded bits is greater than the target number of encoded bits; and
decreasing the tolerance by the predetermined value when the number of the encoded bits is less than the target number of encoded bits.

14. The method of claim 10, wherein the controlling comprises:
increasing the tolerance by a predetermined value when the number of encoded bits is greater than a value of a sum of a change-alleviating value and the target number of encoded bits; and
decreasing the tolerance by a predetermined value when the number of encoded bits is less than the value of a sum of the change-alleviating value and the target number of encoded bits.

15. The method of claim 14, wherein the change-alleviating value is a value acting as a buffer to reduce a number of changes incurred due to a frequent increase or decrease of the tolerance.

16. The method of claim 10, wherein the controlling comprises:
setting the tolerance to zero when the tolerance is a negative number.

17. The method of claim 10, wherein the encoding comprises:
mapping the modulated error to be a positive number; and
calculating, based on errors of the adjacent pixels, Golombk that is a parameter used for performing Golomb-encoding, and Golomb-encoding the mapped modulated error.

18. The method of claim 17, wherein the Golomb-encoding comprises:
calculating Golombk as a smallest n satisfying Equation 6:
MVcnt×2ⁿ≧TSAD, [Equation 6]
wherein MVcnt denotes a number of adjacent pixels used for calculating Golombk, and TSAD denotes a value of summing up all absolute values of errors of the adjacent pixels.
